(19) United States
(12) Patent Application Publication
(10) Pub. No.: US 2006/0260176 A1
(43) Pub. Date: Nov. 23, 2006

(54) Apparatus and method for a reinforced segmented fishing lure

(75) Inventor: Walton Au Yeung, San Wai Court (HK)

Correspondence Address: DORITY & MANNING, P.A., POST OFFICE BOX 1449, GREENVILLE, SC, 29602-1449, US

(73) Assignee: Normark Corporation

(21) Appl. No.: 11/131,537

(22) Filed: May 18, 2005

(51) Int. Cl. A01K 85/18; A01K 85/00

(52) U.S. Cl. 43/42.15; 43/42.24

(57) ABSTRACT

A segmented fishing lure is provided that is reinforced at the joints by a reinforcement material. Also provided is a method of manufacturing a reinforced segmented lure. The segmented fishing lure is capable of swimming in a life-like manner while being retrieved or trolled. The segmented fishing lure is resistant to tearing along the joints of the lure body because of the reinforcement material. However, the segmented fishing lure remains soft and flexible, especially at the joints of the segments. In one exemplary embodiment, the reinforcement material is woven out of reflective polyester strands.

### TECHNICAL FIELD OF THE INVENTION

The present invention generally relates to reinforced, segmented fishing lures and methods of making the same. More specifically, the present invention relates to a reinforced, segmented fishing lure that is capable of swimming in a life-like manner while being trolled or retrieved. The joints of each segment are reinforced by a mesh-like material that extends through the lure body segments and the joint segments. In one embodiment, the mesh-like material comprises a reflective polyester mesh.

### BACKGROUND OF THE INVENTION

Sport fishing is enjoyed around the world. From fresh water to salt water, a wide variety of fish species exist. Fishermen employ a variety of equipment and tackle depending upon the water being fished, the time of day, the species of fish sought, personal choice, and many other factors. A fishing lure, sometimes referred to as an artificial lure, is frequently a part of such equipment and tackle.

Fishing lures are typically designed and decorated with the goal of replicating or mimicking the movement and appearance of a food source for the particular fish being sought. For example, such lure may take on the shape of a minnow, tadpole, frog, mouse, insect, salamander, another fish, or such other food source. The fisherman's hope is that by having a lure closely resembling or acting like a source of food, fish will be enticed into biting the lure.

In an effort to make the lure aesthetically realistic, a designer can use materials pigmented with the desired colors. For example, colored plastics or rubber may be used. In addition, a designer can paint or stain the external surface of the lure to achieve the desired color and marking characteristics. Decorative features such as scales, eyes, and fins may be painted onto the surface or otherwise added to the lure.

Lures can also be designed with features that make the lure realistic in a functional manner. Fins, diving planes, spinners, rattles and the like may be added in order to make the lure move and sound like a food source. Some lures may be specifically designed to operate on the water surface while others may function only when below.

Typically, fishing lures are designed to resemble a bait fish in both appearance and movement. In some lures, the lure body is divided into different segments formed together by various means such that each segment is freely moveable with respect to the other segment. These segments of the lure body enable the lure to swim in a more life-like motion than a single non-segmented lure body. However, the joints of the segments of the lure body are relatively weak compared to the rest of the lure body, especially for soft body lures that closer resemble the texture of a real baitfish. As such, in the past, a continuous lure body defining segments and joints was not strong enough for multiple uses. As such, a need exists for a reinforced, segmented lure that is capable of multiple uses while still remaining soft and flexible to resemble a bait fish while being retrieved or trolled.

### BRIEF SUMMARY OF THE INVENTION

Objects and advantages of the invention will be set forth in part in the following description, or may be obvious from the description, or may be learned through practice of the invention.

Generally, in one embodiment, the present invention is directed to a segmented fishing lure comprising a lure body and a reinforcement film. The lure body has a fish-like shape and has at least two segments connected to each other at a flexible junction. The reinforcement film extends through the lure body to create a flexible junction by connecting each segment to one another while still allowing the segments to remain movable relative to one another. For example, in one embodiment, the lure body defines at lest three segments connected to each other at flexible junctions. In some embodiments, the flexible junctions extend from a top portion of the lure body to the bottom portion of the lure body to allow lateral movement of the lure body segments.

In one embodiment, the reinforcement film is a mesh, such as a metallic mesh. In some embodiments, the reinforcement film can provide reflective surfaces within the lure body. For example, in the embodiment where the reinforcement film is a metallic mesh, the metallic mesh can be reflective and capable of being seen through the lure body. For instance, the lure body can be substantially translucent in some embodiments. In one embodiment, the lure body comprises a soft, flexible plastic material.

In another embodiment, the present invention is generally directed toward a jointed fishing lure that defines a vertical plane between two sides of the lure. In this embodiment, the jointed fishing lure comprises a lure body and a flexible sheet. The lure body defines at least one joint between at least two body portions. The two body portions have fish-like characteristics. The flexible sheet is positioned within the at least two body portions and extends between the body portions to provide the at least one joint configured to allow the two body portions to move relative to each other.

The present disclosure is also generally directed to a method of manufacturing a segmented fishing lure that has a head section and a body section and defines a center between respective sides at the lure. The method includes molding a substantially rigid, plastic insert for positioning in the head section of the lure. A film is also created for positioning along at least the body section of the lure. A mold is provided for forming the overall shape of the lure. The plastic insert is then placed into the mold and the film is suspended along at least the portion of the mold that will form the body section of the lure. The suspending step positions the film at a position that will be substantially along the center of the body section. The mold is then closed and a plastic-based material is injected into the mold to form the lure.

Additional objects and advantages of the present subject matter are set forth in, or will be apparent to, those of ordinary skill in the art from the detailed description herein. Also, it should be further appreciated that modifications and variations to the specifically illustrated, referred and discussed features and elements hereof may be practiced in various embodiments and uses of the invention without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the present subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the present subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification.

### BRIEF DESCRIPTION OF THE DRAWINGS

A full and enabling disclosure of the present invention, including the best mode thereof, directed to one of ordinary skill in the art, is set forth in the specification, which includes and makes reference to the appended figures, in which:

FIG. 1 is a prospective view of an exemplary embodiment of the present invention;

FIG. 2 is a cut-away, prospective view of an exemplary embodiment of the present invention;

FIG. 3 is a top view of an exemplary embodiment of the present invention; and

FIGS. 4A-4C are exemplary embodiments of a method of manufacturing the lure of the present invention.

Repeat use of reference characters throughout the present specification and appended drawings is intended to represent the same or analogous features or elements of the invention.

### DETAILED DESCRIPTION

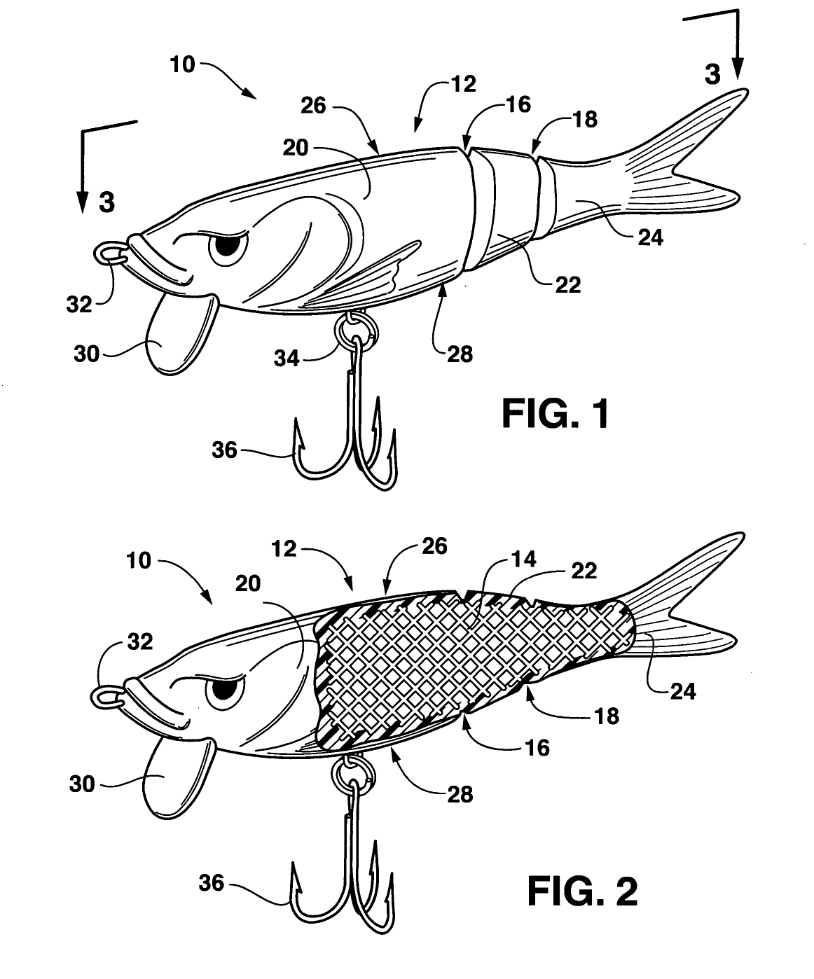

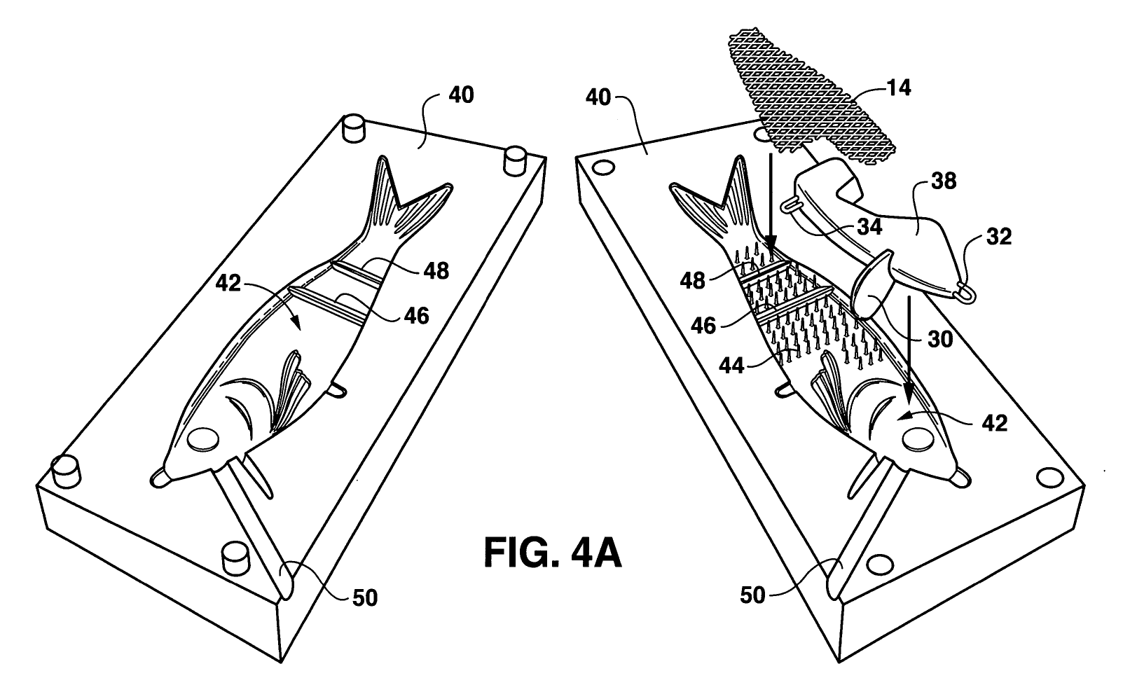

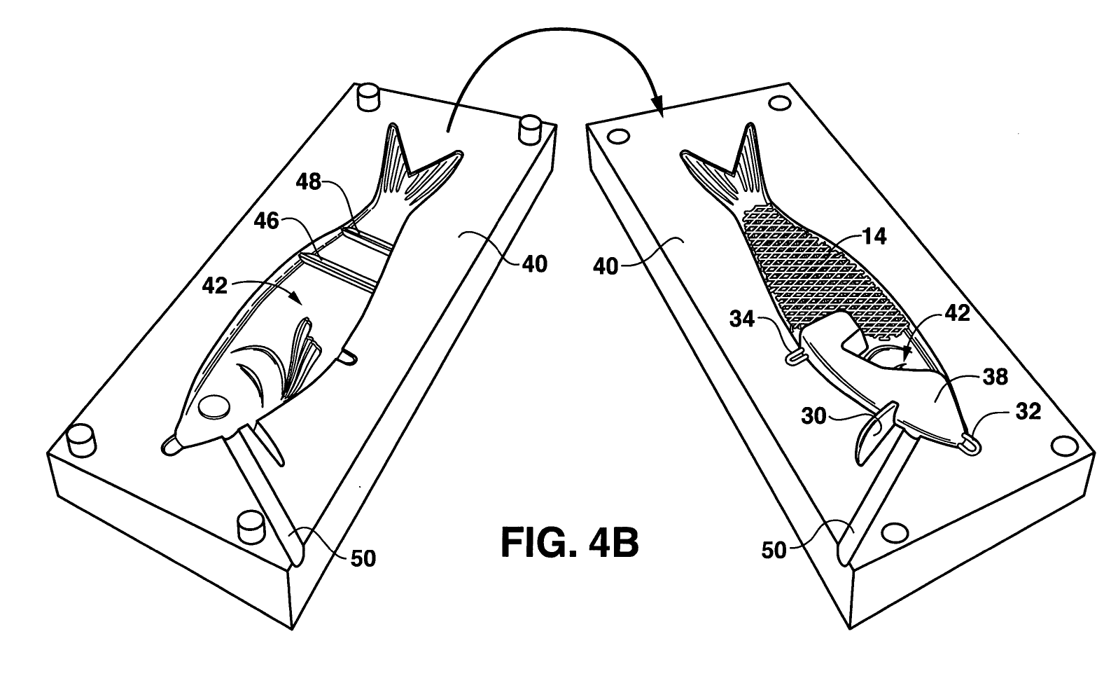

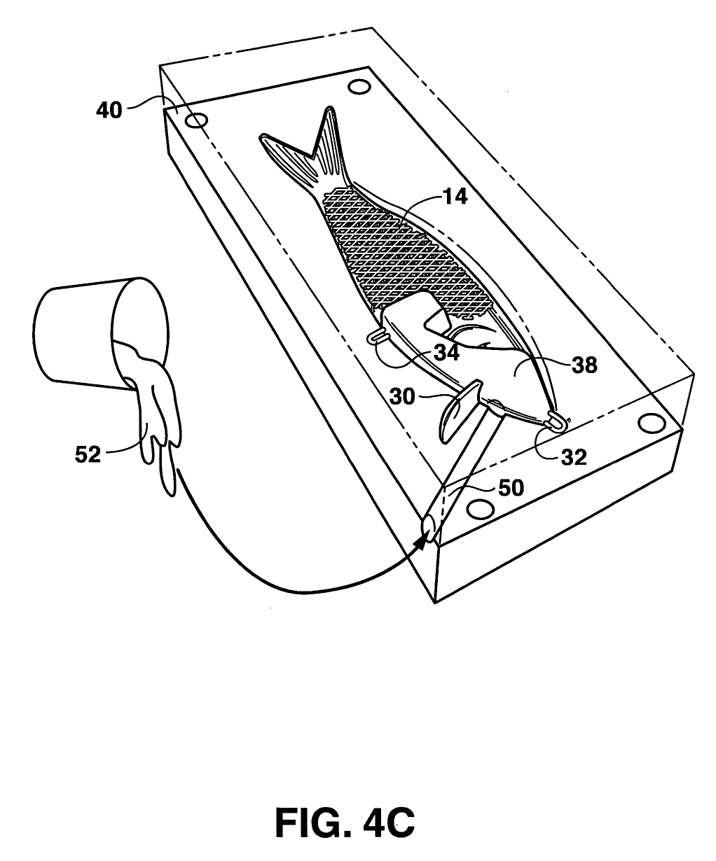

The present invention generally provides for a segmented fishing lure that is reinforced at the joints of the different segments by a metallic mesh-like material. In order to fully understand the advantages of the present disclosure, FIGS. 1-3 will be explained in greater detail as exemplary embodiments of the present invention. The present disclosure also generally provides a method for manufacturing a segmented fishing lure that is reinforced at the joints. FIGS. 4A-4C will be explained in greater detail as providing an exemplary method according to the present invention. Each example is provided by way of explanation of the invention, and not meant as a limitation of the invention. For example, features illustrated or described as part of one embodiment may be used with another embodiment to yield still a further embodiment. In fact, it will be apparent to those skilled in the art that various modifications and variations can be made in the present invention without departing from the scope or spirit of the invention.

Referring to FIGS. 1-3 as exemplary embodiments, the present disclosure generally describes a reinforced, segmented fishing lure 10 comprising a lure body 12 and a mesh-like reinforcement 14. Lure body 12 defines two joints 16 and 18. Mesh-like reinforcement 14 extends through both joints 16 and 18 to reinforce the relatively narrow and otherwise weak area of the joints 16 and 18.

As shown in the exemplary embodiments of FIGS. 1-3, joint 16 divides head section 20 and a middle section 22 of lure body 12, while joint 18 divides middle section 22 and tail section 24. However, any number of joints can be defined along lure body 12 within the scope of the present invention. For example, in one embodiment, lure body 12 may define only one joint, thus comprising only a head section and a tail section. In other embodiments, lure body 12 may define three or more joints.

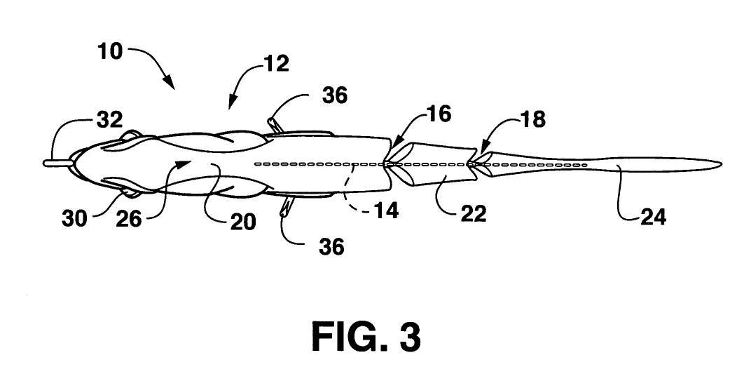

The exemplary embodiments depicted in FIGS. 2 and 3 show that the mesh-like reinforcement 14 is embedded within lure body 12 and generally extends longitudinally from head section 20 through joints 16, middle section 22, and joint 18 to tail section 24. Also, mesh-like reinforcement 14 extends laterally throughout lure 12 from top portion 26 to bottom portion 28. However, mesh-like reinforcement 14 can be any size or shape within lure body 12 as long as joints 16 and 18 are sufficiently reinforced and strong enough to prevent tearing along joints 16 and 18.

FIG. 3 depicts an exemplary embodiment wherein the mesh-like reinforcement 14 is substantially centered within lure body 12. However, mesh-like reinforcement 14 can be positioned anywhere on lure body 12, as long as mesh-like reinforcement 14 extends through joints 16 and 18 to provide additional strength and reinforcement to those joints 16 and 18. For example, in one embodiment, mesh-like reinforcement 14 can be positioned essentially on or within the outside surface of one side of lure body 12.

Mesh-like reinforcement 14 can comprise any material, provided mesh-like reinforcement 14 remains flexible, yet strong enough to reinforce and provide strength to joints 16 and 18. For example, mesh-like reinforcement can be a film, a flexible sheet, or any other relatively flat material. In some embodiments, the mesh-like reinforcement 14 can be manufactured out of any plastic material strong enough to enhance the strength of the lure's joints. For example, in one exemplary embodiment, mesh-like reinforcement 14 can comprise polyester strands. In some embodiments, the mesh-like reinforcement 14 can also be reflective, particularly when the lure body 12 is made of a transparent material, so as to add a decorative function to the mesh-like reinforcement 14. For example, in one embodiment, the mesh-like reinforcement 14 can be made of a reflective polyester, such as the reflective polyester sold under the registered trade name MYLAR by E. I. DuPont De Nemours and Co., Corp. of Delaware.

The mesh-like reinforcement 14 can be a woven or nonwoven mesh. For example, in one particular embodiment, the mesh-like reinforcement 14 can comprise a holographic cloth, which is woven for example out of reflective polyester strands, such as the reflective polyester sold under the registered trade name MYLAR by E. I. DuPont De Nemours and Co., Corp. of Delaware. In other embodiments, the mesh-like reinforcement 14 can be formed in pressing the reinforcement into the desired shape by the use of a press.

Joints 16 and 18 allow lure body 12 to better mimic a real bait fish while being trolled or retrieved by increasing the flexibility of lure body 12. Even if lure body 12 is made of an inflexible or rigid material, joints 16 and 18 allow lure body 12 to be flexible, at least at joints 16 and 18. However, in a preferred embodiment, joints 16 and 18 add flexibility to lure body 12 even when lure body 12 comprises a relatively flexible and soft material. In this embodiment, the shape of joints 16 and 18 helps control the type and direction of the movement of lure body 12 while being fished. For example, in the exemplary embodiments depicted in FIGS. 1-3, joints 16 and 18 extend the entire height of lure body 12, from bottom portion 28 to top portion 26. As such, lure body 12 is more flexible in the lateral movement, allowing middle section 22 and tail section 24 to more easily move from side to side, mimicking a swimming bait fish.

In the exemplary embodiments of FIGS. 1-3, lure 10 is shown to include diving plane 30 that helps lure 10 dive below the surface of the water while being fished. Also, lure 10 is shown including line loop 32 for attachment of lure 10 to a fishing line (not shown). Lure 10 can be connected to a fishing line at line loop 32 by any method, including for example, tying or crimping. Furthermore, lure 10 includes hook ring 34 attached to bottom portion 28 of lure 10. Hook 36 is attached to hook ring 34; however, any means of attaching hook 36 to lure 10 can be utilized. In the embodiment shown, hook 36 is a treble hook. However, in other embodiments, another hook, such as a single or double hook, can be utilized.

As best shown by reference to the exemplary method of making the segmented lure of the present disclosure depicted in FIGS. 4A-4C, line loop 32, diving plane 30, and hook ring 34 are all connected internally in lure body 12 as a head insert 38. In the embodiment shown, line loop 32 and hook ring 34 are metallic pieces set into a hard plastic, molded material that comprises head insert 38. In some embodiments, insert 38 can also include a weight internally set into head insert 38.

An exemplary method of making the segmented lure of the present invention is generally depicted in FIGS. 4A-4C. A two piece mold 40 is provided that defines space 42 when folded together. Space 42 is shaped and configured to mold the lure 10. As such, any feature of space 42 will appear on the outside of lure 10. Joints 16 and 18 are formed by the shape of space 42 at joint-forming extrusions 46 and 48, respectively.

To manufacture lure 10, head insert 38 is placed within the space 42 of mold 40. Also, mesh-like reinforcement 14, which has been previously cut to a desired length and width, is placed inside space 42 of mold 40 and rested on needle-like extensions 44. In this embodiment, mesh-like reinforcement 14 is suspended above the surface of mold 40 so it can positioned within lure body 12. However, in other embodiments, mesh-like reinforcement 14 can be simply placed on the surface of mold 40 so that it is located on the outer surface of lure 10.

Once mesh-like reinforcement 14 and head insert 38 are placed into space 42 of two piece mold 40, two piece mold 40 is folded together to close space 42 except for material acceptor channel 50. Once mold 40 is closed, then plastic based material 52 can be injected into mold 40, through material acceptor channel 50. Plastic based material 52 can be any plastic material capable of being molded into the desired shape formed by mold 40. For example, in one embodiment, plastic based material 52 can comprise polyvinyl chloride.

After the plastic based material 52 is set in the mold 40, lure 10 can be removed from the mold 40. Then, lure 10 can be decorated to include various colors and other features, such as fins, scales, gills, and other fish features to make the lure 10 more resemble a bait fish. For example, color can be sprayed or printed onto lure 10. Also, hook 36 can be attached to hook ring 34.

While the present subject matter has been described in detail with respect to specific embodiments thereof, it will be appreciated that those skilled in the art, upon attaining and understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations, and/or additions to the present subject matter as would be readily apparent to one of ordinary skill in the art.

What is claimed is:

1. A segmented fishing lure, comprising:
a lure body having a fish-like shape, said lure body having at least two segments, wherein each said segment is connected to each other at a flexible junction;
a reinforcement film extending through said lure body to create said flexible junction by connecting each said segment to one another while still allowing said segments to remain movable relative to one another.

2. A segmented fishing lure as in claim 1, wherein said reinforcement film is a mesh.

3. A segmented fishing lure as in claim 2, wherein said reinforcement film provides reflective surfaces within said lure body.

4. A segmented fishing lure as in claim 1, wherein said lure body defines at least three segments connected to each other at flexible junctions.

5. The segmented fishing lure of claim 1, wherein said lure body further defines a top portion and a bottom portion, and said flexible junction extends from said top portion to said bottom portion so as to allow lateral movement of said lure body segments.

6. The segmented fishing lure of claim 1, wherein said reinforcement film is woven from polyester strands.

7. The segmented fishing lure of claim 6, wherein said woven polyester strands are also reflective and capable of being substantially seen through said lure body.

8. The segmented fishing lure of claim 1, wherein said lure body is substantially translucent.

9. The segmented fishing lure of claim 1, wherein said lure body comprises a soft, flexible plastic material.

10. A jointed fishing lure, said fishing lure defining a vertical plane between two sides of the lure, said lure comprising:
a lure body defining at least one joint between at least two body portions, said two body portions having fish-like characteristics; and
a flexible sheet positioned within said at least two body portions and extending between said body portions to provide said at least one joint configured to allow said two body portions to move relative to one another.

11. A jointed fishing lure as in claim 10, wherein said lure body defines at least two joints.

12. A jointed fishing lure as in claim 10, wherein said flexible sheet is located substantially along the vertical plane between the two sides of the lure.

13. A jointed fishing lure as in claim 12, wherein said flexible sheet is reflective.

14. A jointed fishing lure as in claim 13, wherein said at least two lure body portions are constructed from a translucent material.

15. A jointed fishing lure as in claim 14, wherein said flexible sheet is comprised of reflective polyester strands.

16. A method of manufacturing a segmented fishing lure having a head section and a body section and defining a center between respective sides of the lure, comprising the steps of:
molding a substantially rigid, plastic insert for positioning in the head section of the lure;
creating a film for positioning along at least the body section of the lure;
providing a mold for forming the overall shape of the lure;
placing the plastic insert into the mold;
suspending the film along at least that portion of the mold that will form the body section of the lure, wherein said suspending step positions said film at a position that will be substantially along the center of the body section;
closing the mold; and injecting a plastic-based material into the mold to form the lure.

17. A method of manufacturing a segmented fishing lure as in claim 16, wherein said creating step comprises placing the film into a press to form the film into the desired shape.

18. A method of manufacturing a segmented fishing lure as in claim 17, further comprising the step of placing a lead weight into the head section of the lure before said step of closing the mold.

19. A method of manufacturing a segmented fishing lure as in claim 18, wherein said providing step comprises positioning pin-like projection along an interior surface of the mold that are configured for receipt of the film.

20. A method of manufacturing a segmented fishing lure as in claim 19, further comprising:
removing the lure from the mold after said injecting step;
spraying color onto the lure; and
attaching ornamental fish features to the lure.
